(19) United States
(12) Patent Application Publication
(10) Pub. No.: US 2025/0055614 A1
(43) Pub. Date: Feb. 13, 2025

(54) VIRTUAL HOPS FOR PHYSICAL UPLINK CONTROL CHANNEL

(71) Applicant: QUALCOMM Incorporated, San Diego, CA (US)

(72) Inventors: Yi HUANG, San Diego, CA (US); Peter GAAL, San Diego, CA (US); Gabi SARKIS, San Diego, CA (US); Le LIU, San Jose, CA (US)

(21) Appl. No.: 18/433,979

(22) Filed: Feb. 6, 2024

Related U.S. Application Data
(60) Provisional application No. 63/519,132, filed on Aug. 11, 2023.

(51) Int. Cl. H04L 5/00; H04L 27/26; H04W 72/21

(52) U.S. Cl. CPC H04L 5/0016; H04L 5/0012; H04L 5/0051; H04L 27/2636; H04W 72/21

(57) ABSTRACT

Various aspects of the present disclosure generally relate to wireless communication. In some aspects, a user equipment (UE) may apply a discrete Fourier transform (DFT) orthogonal cover code (OCC) to a first virtual hop that is associated with a physical uplink control channel (PUCCH) transmission. The UE may apply the DFT OCC to a second virtual hop that is associated with the PUCCH transmission, wherein the first virtual hop and the second virtual hop are associated with equal quantities of orthogonal frequency-division multiplexing (OFDM) symbols, wherein a size of the DFT OCC is based at least in part on the quantities of OFDM symbols, and wherein the first virtual hop and the second virtual hop are not associated with physical frequency hopping. Numerous other aspects are described.

### CROSS-REFERENCE TO RELATED APPLICATION

This Patent application claims priority to U.S. Provisional Patent Application No. 63/519,132, filed on Aug. 11, 2023, entitled “VIRTUAL HOPS FOR PHYSICAL UPLINK CONTROL CHANNEL,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for virtual hops for the physical uplink control channel.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to cause the UE to apply a discrete Fourier transform (DFT) orthogonal cover code (OCC) to a first virtual hop that is associated with a physical uplink control channel (PUCCH) transmission. The one or more processors may be configured to cause the UE to apply the DFT OCC to a second virtual hop that is associated with the PUCCH transmission, wherein the first virtual hop and the second virtual hop are associated with equal quantities of orthogonal frequency-division multiplexing (OFDM) symbols, wherein a size of the DFT OCC is based at least in part on the quantities of OFDM symbols, and wherein the first virtual hop and the second virtual hop are not associated with physical frequency hopping.

Some aspects described herein relate to a network node for wireless communication. The network node may include one or more memories and one or more processors coupled to the one or more memories. The one or more processors may be configured to cause the network node to obtain a first virtual hop that is associated with a PUCCH transmission, wherein a DFT OCC is applied to the first virtual hop. The one or more processors may be configured to cause the network node to obtain a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

Some aspects described herein relate to a method of wireless communication performed by a UE. The method may include applying a DFT OCC to a first virtual hop that is associated with a PUCCH transmission. The method may include applying the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping.

Some aspects described herein relate to a method of wireless communication performed by a network node. The method may include obtaining a first virtual hop that is associated with a PUCCH transmission, wherein a DFT OCC is applied to the first virtual hop. The method may include obtaining a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

Some aspects described herein relate to a non-transitory computer-readable medium that stores a set of instructions for wireless communication by a UE. The set of instructions, when executed by one or more processors of the UE, may cause the UE to apply a DFT OCC to a first virtual hop that is associated with a PUCCH transmission. The set of instructions, when executed by one or more processors of the UE, may cause the UE to apply the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping.

Some aspects described herein relate to a non-transitory computer-readable medium that stores a set of instructions for wireless communication by a network node. The set of instructions, when executed by one or more processors of the network node, may cause the network node to obtain a first virtual hop that is associated with a PUCCH transmission, wherein a DFT OCC is applied to the first virtual hop. The set of instructions, when executed by one or more processors of the network node, may cause the network node to obtain a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

Some aspects described herein relate to an apparatus for wireless communication. The apparatus may include means for applying a DFT OCC to a first virtual hop that is associated with a PUCCH transmission. The apparatus may include means for applying the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping.

Some aspects described herein relate to an apparatus for wireless communication. The apparatus may include means for obtaining a first virtual hop that is associated with a PUCCH transmission, wherein a DFT OCC is applied to the first virtual hop. The apparatus may include means for obtaining a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical uplink control channel (PUCCH) format 1 multiplexing, in accordance with the present disclosure.

FIG. 5 is a diagram illustrating an example of a PUCCH multiplexing issue without sequence hopping and example of a PUCCH multiplexing issue with sequence hopping, in accordance with the present disclosure.

FIG. 6 is a diagram illustrating an example of a system that includes a UE that is not configured for frequency hopping and a UE that is configured for frequency hopping, in accordance with the present disclosure.

FIG. 7 is a diagram illustrating an example of using virtual hops for PUCCH, in accordance with the present disclosure.

FIG. 8 is a diagram illustrating an example involving virtual hops without sequence hopping and an example involving virtual hops with sequence hopping, in accordance with the present disclosure.

FIG. 9 is a diagram illustrating an example involving block-level orthogonal cover code (OCC) for virtual hops without sequence hopping and an example involving block-level OCC for virtual hops with sequence hopping, in accordance with the present disclosure.

FIG. 10 is a diagram illustrating an example involving a legacy discrete Fourier transform (DFT) matrix and an example involving a DFT matrix that is computed based on block-level OCC and a half-sized DFT orthogonal cover code (OCC) matrix, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

A user equipment (UE) that is not configured for frequency hopping has a different discrete Fourier transform (DFT) orthogonal cover code (OCC) size than a UE that is configured for frequency hopping. For example, the DFT OCC size of a UE with frequency hopping may be half of the DFT OCC size of a UE without frequency hopping. The difference in DFT OCC sizes between UEs that are configured for frequency hopping and UEs that are not configured for frequency hopping can prevent UEs that are configured for frequency hopping from multiplexing with UEs that are not configured for frequency hopping. Furthermore, if a UE configured for frequency hopping uses a different sequence than a UE that is not configured for frequency hopping, then the difference in sequences can also prevent the UEs from multiplexing with each other. The inability of UEs to multiplex with each other can contribute to congestion of available bandwidth.

Various aspects relate generally to physical uplink control channel (PUCCH) transmissions. Some aspects more specifically relate to virtual hops for PUCCH transmissions. In some examples, a UE that is not configured for frequency hopping may apply a DFT OCC to a first virtual hop associated with a PUCCH transmission (e.g., a PUCCH format 1 transmission) and apply the DFT OCC to a second virtual hop associated with the PUCCH transmission. The first virtual hop and the second virtual hop may not be associated with physical frequency hopping, may be associated with (e.g., have, contain, or the like) the same quantities of orthogonal frequency-division multiplexing (OFDM) symbols, and may be associated with DFT OCC of equal sizes. In some aspects, the first virtual hop or the second virtual hop may be multiplexed with a hop of another PUCCH transmission on a resource block (RB). The hop of the other PUCCH transmission may be transmitted by another UE that is configured for frequency hopping and may be associated with another DFT OCC having the same size as the DFT OCC of the first or second virtual hops. The virtual hops may use the same demodulation reference signal (DMRS) sequence (e.g., no sequence hopping) or different DMRS sequences (e.g., sequence hopping). In either case, the hop that a virtual hop (e.g., the first or second virtual hop) is multiplexed with may use the same DMRS sequence as that virtual hop. In some aspects, a block-level OCC (e.g., block-wise OCC code) may be applied to the first virtual hop and the second virtual hop.

Particular aspects of the subject matter described in this disclosure can be implemented to realize one or more of the following potential advantages. In some examples, by applying the DFT OCC to the first and second virtual hops, the described techniques can be used to multiplex the first virtual hop and/or the second virtual hop with hops of PUCCH transmissions that involve physical frequency hopping, which may decrease congestion of available bandwidth. For example, the first virtual hop and/or the second virtual hop may have the same DFT OCC size as that of the hops that involve frequency hopping, which may enable the virtual hops (which are not associated with physical frequency hopping) to be multiplexed on the same RB as hops that are associated with frequency hopping, thereby conserving RB usage. The first and second virtual hops being associated with the same DMRS sequence may enable the multiplexing of virtual hops in scenarios without sequence hopping, and the first and second virtual hops being associated with different DMRS sequences may enable the multiplexing of virtual hops in scenarios with sequence hopping. The block-level OCC being applied to the first virtual hop and the second virtual hop may increase multiplexing capacity (e.g., the maximum quantity of UEs that can be multiplexed) that would otherwise be reduced (e.g., halved) for users without frequency hopping due to reduction (e.g., halving) of the size of the DFT OCC.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

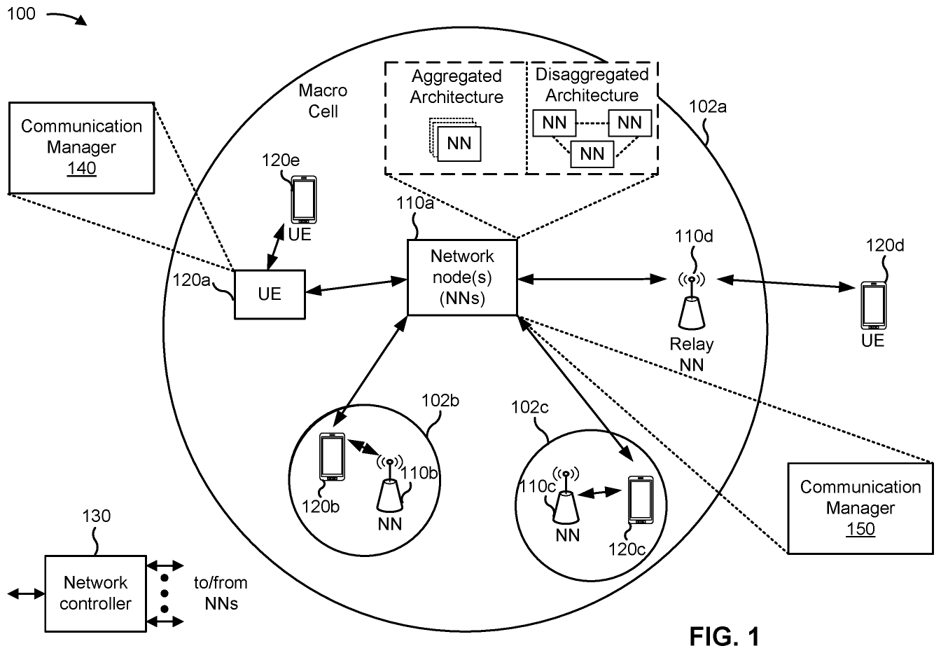

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an CNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may apply a DFT OCC to a first virtual hop that is associated with a PUCCH transmission; and apply the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping. Additionally, or alternatively, the communication manager 140 may perform one or more other operations described herein.

In some aspects, the network node 110 may include a communication manager 150. As described in more detail elsewhere herein, the communication manager 150 may obtain a first virtual hop that is associated with a PUCCH transmission, wherein a DFT OCC is applied to the first virtual hop; and obtain a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping. Additionally, or alternatively, the communication manager 150 may perform one or more other operations described herein.

As indicated above, FIG. 1 is provided as an example. Other examples may differ from what is described with regard to FIG. 1.

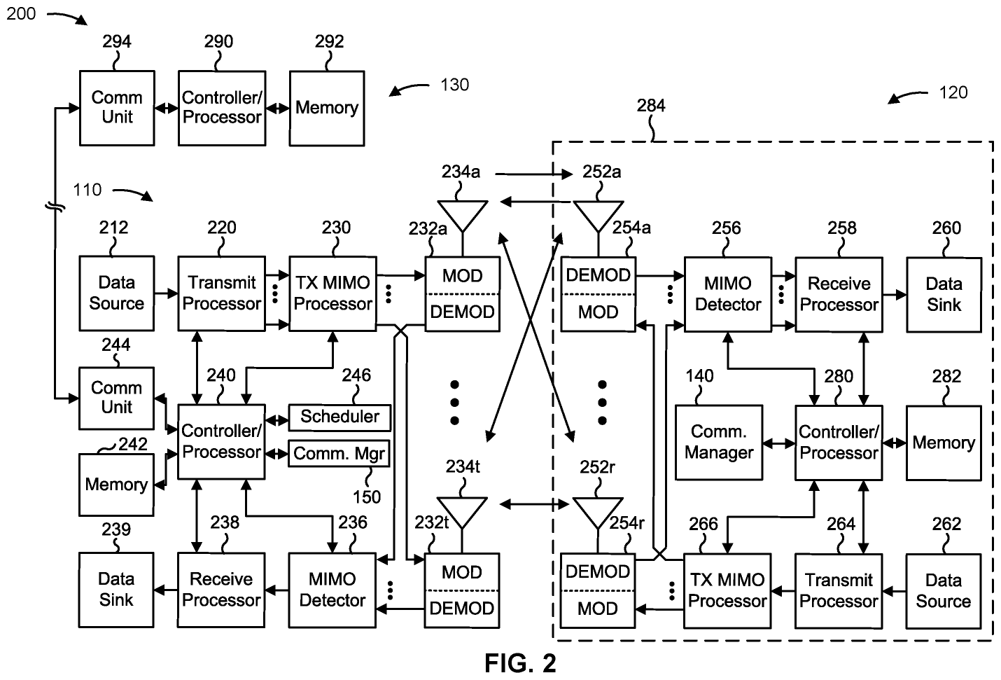

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

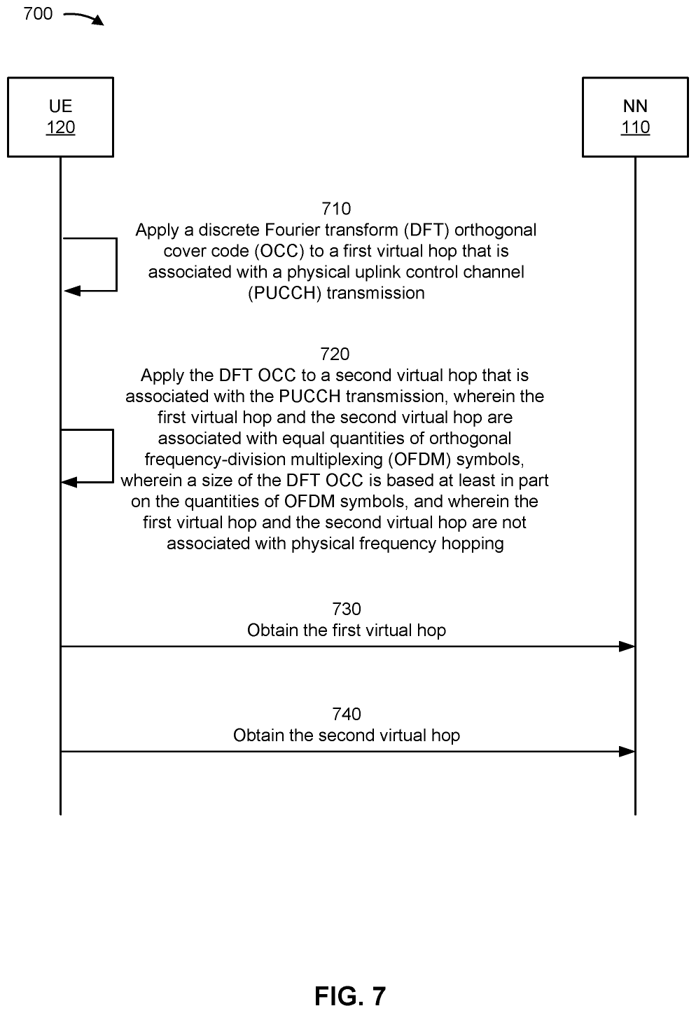

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

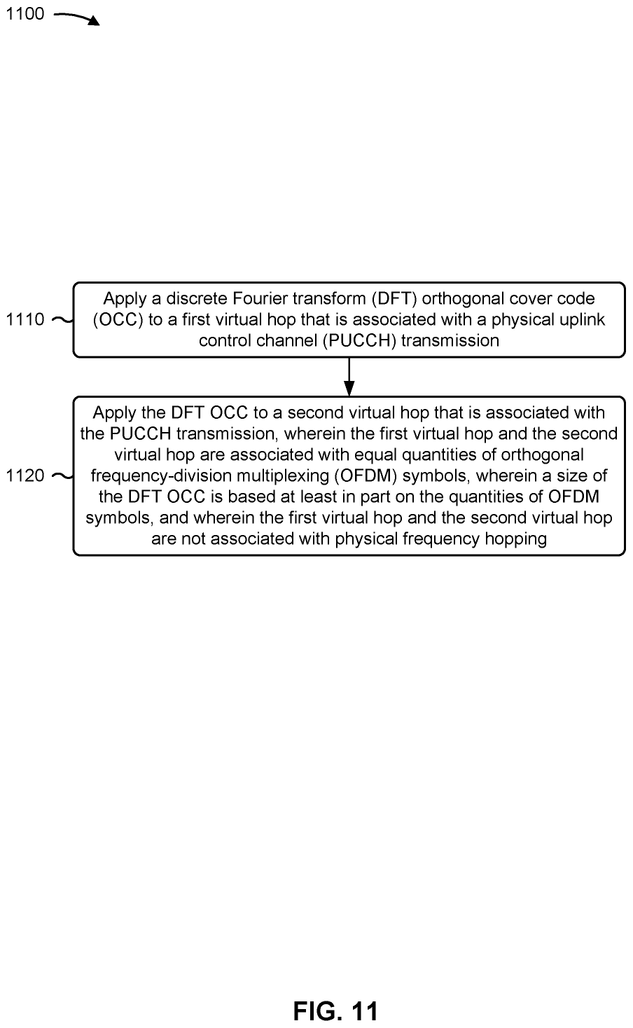

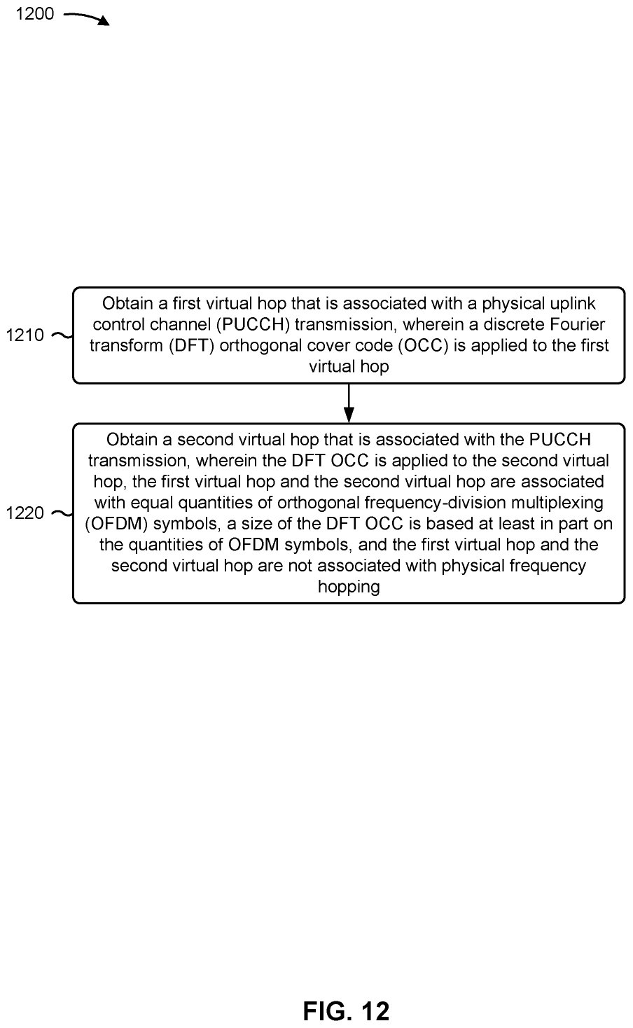

The controller/processor 240 of the network node 110, the controller/processor 280 of the UE 120, and/or any other component(s) of FIG. 2 may perform one or more techniques associated with virtual hops for the PUCCH, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for applying a DFT OCC to a first virtual hop that is associated with a PUCCH transmission; and/or means for applying the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for obtaining a first virtual hop that is associated with a PUCCH transmission, wherein a DFT OCC is applied to the first virtual hop; and/or means for obtaining a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

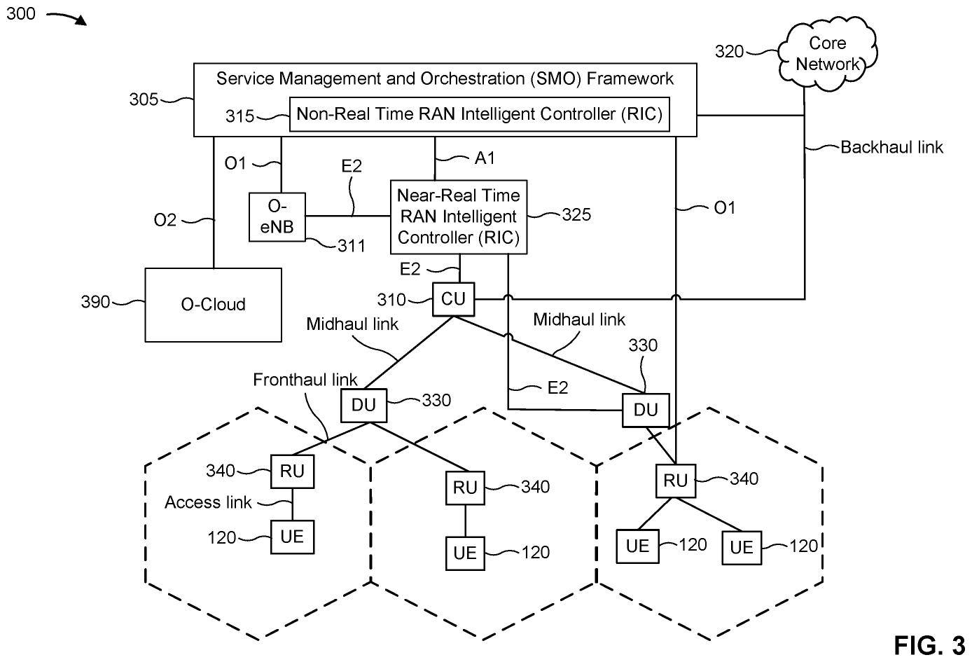

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

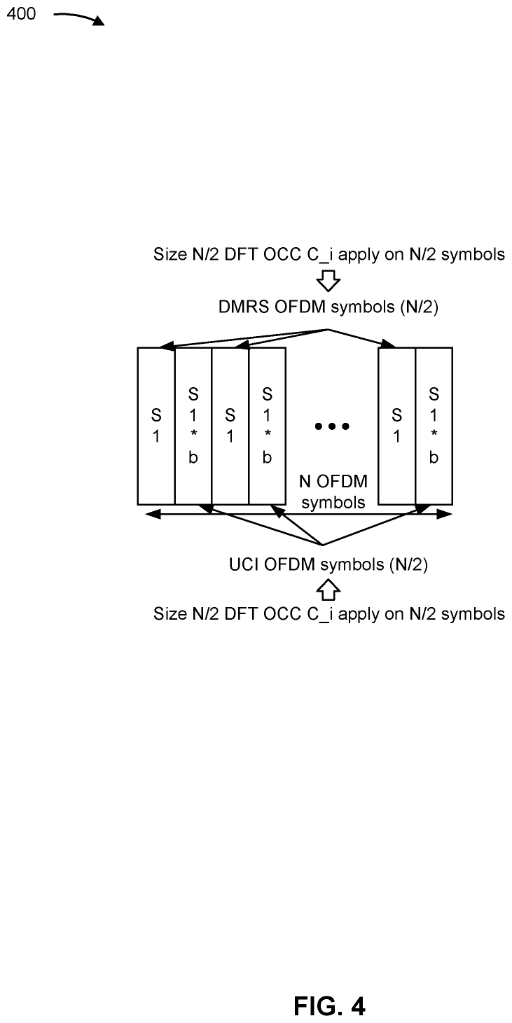

FIG. 4 is a diagram illustrating an example 400 of PUCCH format 1 multiplexing, in accordance with the present disclosure.

PUCCH format 1 includes a one- or two-bit payload with 4-14 OFDM symbols. For a given cell-specific base sequence S having length 12, the one- or two-bit payload b may be transmitted as follows. A sequence S1 (which is base sequence S with a cyclic shift amount or index CS1) may be transmitted as a DMRS on even OFDM symbols and modulated by the payload b on odd OFDM symbols. For a user i, a size N/2 DFT OCC C_i is applied on the DMRS symbols and a size N/2 DFT OCC C_i is applied on the uplink control information (UCI) symbols. Using different OCC C_i for another user j may enable the user i and the user j to be multiplexed on the same RB.

As indicated above, FIG. 4 is provided as an example. Other examples may differ from what is described with respect to FIG. 4.

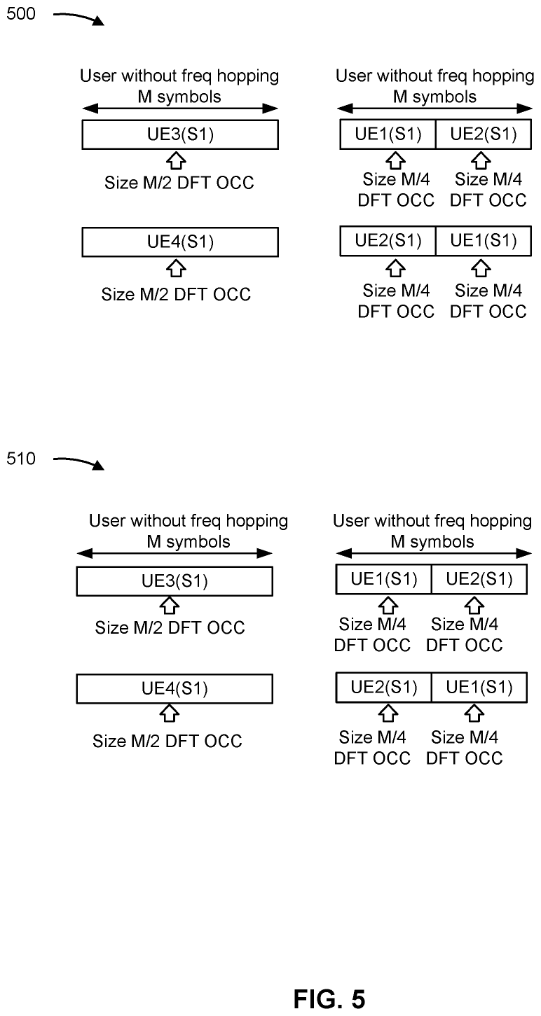

FIG. 5 is a diagram illustrating an example 500 of a PUCCH multiplexing issue without sequence hopping and example 510 of a PUCCH multiplexing issue with sequence hopping, in accordance with the present disclosure.

As shown in example 500, UEs that are not configured for frequency hopping have different DFT OCC sizes than UEs that are configured for frequency hopping. For example, the DFT OCC sizes of UE1 and UE2 (with frequency hopping) is half of the DFT OCC sizes of UE3 and UE4 (without frequency hopping). The difference in DFT OCC sizes between UEs that are configured for frequency hopping and UEs that are not configured for frequency hopping prevents UEs that are configured for frequency hopping from multiplexing with UEs that are not configured for frequency hopping.

In example 510, UEs that are configured for frequency hopping are also configured for sequence hopping. For example, UE1 and UE2 use S1 for the first frequency hop and S2 for the sequence hop. However, UE3 and UE4 (which are not configured for frequency hopping) use only S1. The difference in sequences between UEs that are configured for frequency hopping and UEs that are not configured for frequency hopping also prevents UEs that are configured for frequency hopping from multiplexing with UEs that are not configured for frequency hopping.

As indicated above, FIG. 5 is provided as an example. Other examples may differ from what is described with respect to FIG. 5.

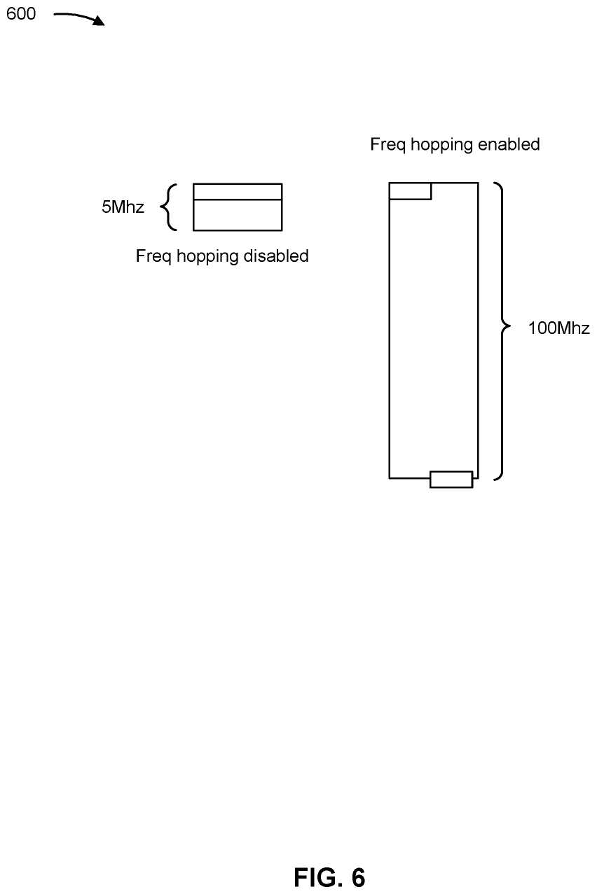

FIG. 6 is a diagram illustrating an example 600 of a system that includes a UE that is not configured for frequency hopping and a UE that is configured for frequency hopping, in accordance with the present disclosure.

Many systems (e.g., 5G systems, 6G systems, or the like) include (or will include) UEs with different bandwidth capabilities. For example, the system in example 600 includes a UE with small bandwidth capabilities (e.g., 5 MHz capabilities) and a wideband UE (e.g., 100 MHz capabilities). Enabling frequency hopping for the UE with small bandwidth capabilities may induce spectrum fragmentation for the wideband UE without achieving a frequency hopping gain (due to the small hopping range of 5 MHz). As a result, many systems may include UEs that are configured for frequency hopping (e.g., the wideband UE) and UEs that are not configured for frequency hopping (e.g., the UE with small bandwidth capabilities), which, as discussed above in connection with FIG. 5, are not compatible for multiplexing. As a result, transmissions from UEs that are configured for frequency hopping and UEs that are not configured for frequency hopping occupy different RBs, which can contribute to congestion of available bandwidth.

As indicated above, FIG. 6 is provided as an example. Other examples may differ from what is described with respect to FIG. 6.

FIG. 7 is a diagram illustrating an example 700 of using virtual hops for PUCCH, in accordance with the present disclosure.

As shown by reference number 710, a UE (e.g., UE 120) applies a DFT OCC to a first virtual hop. The first virtual hop is associated with a PUCCH transmission (e.g., a PUCCH format 1 transmission). As shown by reference number 720, the UE applies the DFT OCC to a second virtual hop that is associated with the PUCCH transmission. This first virtual hop and the second virtual hop may be associated with (e.g., have, contain, or the like) equal quantities of OFDM symbols. In some aspects, the DFT OCC may be OFDM symbol-level OCC.

A size of the DFT OCC may be based at least in part on the quantities of OFDM symbols. For example, the first virtual hop and the second virtual hop may have the same quantity of OFDM symbols and be associated with DFT OCC of equal sizes.

The virtual hops may not be associated with physical frequency hopping. For example, the UE may transmit both virtual hops over the same frequency. The UE may not be configured for frequency hopping (e.g., the UE may have small bandwidth capabilities). The hops are “virtual” because the UE may treat the virtual hops as actual frequency hops for purposes of applying the DFT OCC. For example, rather than applying a DFT OCC of a larger size across both virtual hops, the UE may individually (e.g., separately) apply the DFT OCC to each virtual hop.

As shown by reference number 730, the UE may transmit, and a network node (e.g., network node 110) may receive, the first virtual hop. As shown by reference number 740, the UE may transmit, and the network node may receive, the second virtual hop. The UE may transmit, and the network node may receive, the first and second virtual hops on the same frequency (e.g., without frequency hopping).

In some aspects, a hop of another PUCCH transmission (e.g., another PUCCH format 1 transmission) is multiplexed with the first virtual hop or the second virtual hop on an RB. The hop may be associated with another DFT OCC having the same size as the DFT OCC of the first or second virtual hops. For example, the other UE may apply the other DFT OCC to the hop of the other PUCCH transmission. In some aspects, the other UE may transmit the hop, and the network node may receive the hop multiplexed with the first or second virtual hop on the RB.

The hop of the other PUCCH transmission may be associated with physical frequency hopping. For example, the other PUCCH transmission may be transmitted by another UE that is configured for frequency hopping (e.g., a wideband UE) that transmits the hop over a first frequency and another hop of the other PUCCH transmission over a second frequency.

The UE applying the DFT OCC to the first virtual hop and applying the DFT OCC to the second virtual hop, and/or the network node obtaining the first and second virtual hops, may enable the first virtual hop and/or the second virtual hop to be multiplexed with hops of PUCCH transmissions that involve frequency hopping. For example, the first virtual hop and/or the second virtual hop may have the same DFT OCC size as the DFT OCC size of the hops of PUCCH transmissions that involve frequency hopping, which may enable the virtual hops (which are not associated with physical frequency hopping) to be multiplexed on the same RB as hops that are associated with frequency hopping.

The virtual hops (e.g., virtual hops of UEs that are not configured for frequency hopping) being multiplexed on an RB with other hops may conserve RB usage. For example, the virtual hops being multiplexed on an RB with hops that are associated with frequency hopping (e.g., hops of UEs that are configured for frequency hopping) may enable PUCCH transmissions of UEs that are not configured for frequency hopping (e.g., UEs operable in a small bandwidth) to be multiplexed with PUCCH transmissions of UEs that are configured for frequency hopping (e.g., wideband UEs).

As indicated above, FIG. 7 is provided as an example. Other examples may differ from what is described with respect to FIG. 7.

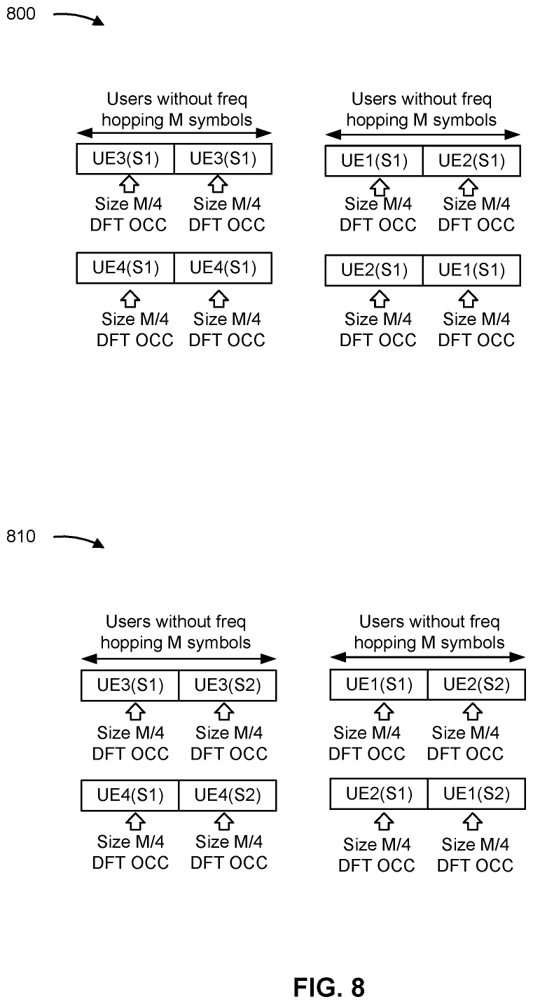

FIG. 8 is a diagram illustrating an example 800 involving virtual hops without sequence hopping and an example 810 involving virtual hops with sequence hopping, in accordance with the present disclosure.

In example 800, a first virtual hop is associated with a sequence (e.g., a DMRS sequence) and a second virtual hop is associated with the sequence. For example, UE3 and UE4 use virtual hops. The virtual hops associated with UE3 have the same sequence S1, and the virtual hops associated with UE4 have the same sequence S1. The first and second virtual hops being associated with the sequence may enable the multiplexing of virtual hops in scenarios without sequence hopping.

A hop of another PUCCH transmission (e.g., another PUCCH format 1 transmission) that is multiplexed with the first virtual hop or the second virtual hop on an RB may be associated with the sequence. For example, the hops (e.g., actual frequency hops) associated with UE1 and UE2 also have sequence S1. In some examples, UE3 may transmit a first virtual hop that is multiplexed with a hop transmitted by UE1, and UE3 may transmit a second virtual hop that is multiplexed with a hop transmitted by UE2. In some examples, UE4 may transmit a first virtual hop that is multiplexed with a hop transmitted by UE2, and UE4 may transmit a second virtual hop that is multiplexed with a hop transmitted by UE1. In some aspects, a network node may obtain a hop transmitted by UE1 or UE2 multiplexed with a virtual hop transmitted by UE3 or UE4 on the same RB.

In example 810, a first virtual hop is associated with a first sequence (e.g., a first DMRS sequence) and a second virtual hop is associated with a second sequence (e.g., a second DMRS sequence that is different from the first DMRS sequence). For example, a first virtual hop associated with UE3 has sequence S1, and a second virtual hop associated with UE4 has sequence S2. Likewise, a first virtual hop associated with UE4 has sequence S1, and a second virtual hop associated with UE4 has sequence S2. The first and second virtual hops being associated with different sequences may enable the multiplexing of virtual hops in scenarios with sequence hopping.

In some examples, a hop of another PUCCH transmission (e.g., another PUCCH format 1 transmission) that is multiplexed with the first virtual hop on an RB may be associated with the first sequence. For example, a first hop (e.g., an actual frequency hop) associated with UE1 may be multiplexed with the first virtual hop of UE3 and also have sequence S1. Likewise, a first hop (e.g., an actual frequency hop) associated with UE2 may be multiplexed with the first virtual hop of UE4 and also have sequence S1. A second hop (e.g., an actual frequency hop) associated with UE1 may be multiplexed with the second virtual hop of UE3 and also have sequence S2. Likewise, a second hop (e.g., an actual frequency hop) associated with UE1 may be multiplexed with the first virtual hop of UE4 and also have sequence S2.

In some examples, UE3 may transmit a first virtual hop, which may be multiplexed with the first hop transmitted by UE1, and UE3 may transmit a second virtual hop, which may be multiplexed with the second hop transmitted by UE2. In some examples, UE4 may transmit a first virtual hop that is multiplexed with the first hop transmitted by UE2, and UE4 may transmit a second virtual hop that is multiplexed with the second hop transmitted by UE1. In some aspects, the network node may obtain, on the same RB, the first virtual hop of UE3 multiplexed with the first virtual hop transmitted by UE1, the second virtual hop of UE3 multiplexed with the second virtual hop transmitted by UE2, the first virtual hop of UE4 multiplexed with the first virtual hop transmitted by UE2, or the second virtual hop of UE4 multiplexed with the second virtual hop transmitted by UE1.

As indicated above, FIG. 8 is provided as an example. Other examples may differ from what is described with respect to FIG. 8.

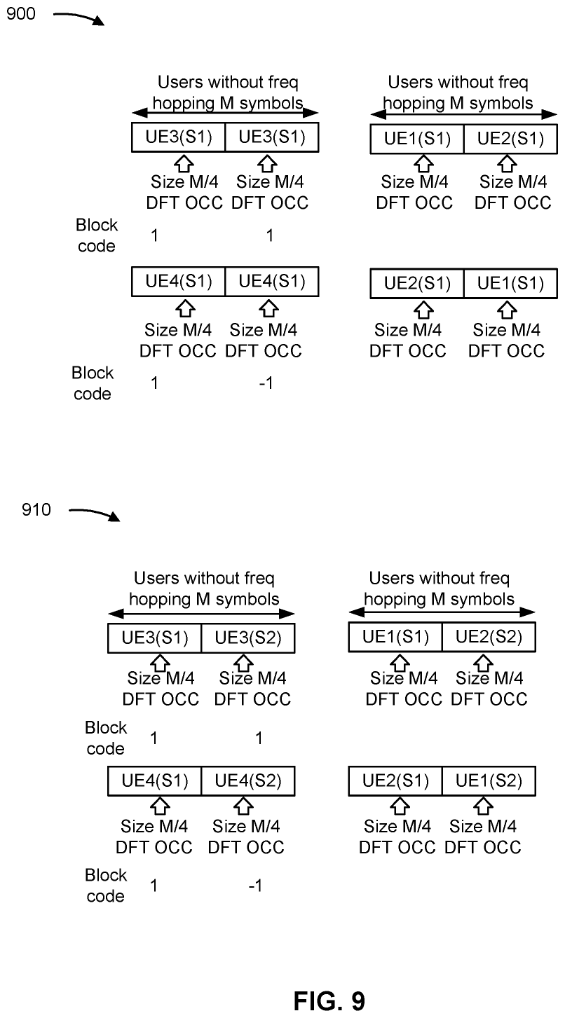

FIG. 9 is a diagram illustrating an example 900 involving block-level OCC for virtual hops without sequence hopping and an example 910 involving block-level OCC for virtual hops with sequence hopping, in accordance with the present disclosure.

In examples 900 and 910, a block-level OCC (e.g., block-wise OCC code) is applied to the first virtual hop and the second virtual hop. The block-level OCC code may be virtual-hop-level code. In example 900, the block-level OCC is applied to virtual hops without sequence hopping (virtual hops without sequence hopping are discussed above in relation to example 800 (FIG. 8)). In example 910, the block-level OCC is applied to virtual hops with sequence hopping (virtual hops with sequence hopping is discussed above in relation to example 810 (FIG. 8)). In both examples 900 and 910, the block-level OCC applied to the first and second virtual hops for UE3 is [1,1] (e.g., “1” is applied to the first virtual hop, and “1” is applied to the second virtual hop), and the block-level OCC applied to the first and second virtual hops for UE4 is [1,−1] (e.g., “1” is applied to the first virtual hop, and “−1” is applied to the second virtual hop).

The block-level OCC being applied to the first virtual hop and the second virtual hop may increase multiplexing capacity (e.g., the maximum quantity of UEs that can be multiplexed) that would otherwise be reduced (e.g., halved) for users without frequency hopping due to reduction (e.g., halving) of the size of the DFT OCC. Thus, PUCCH transmissions with frequency hopping and PUCCH transmission without frequency hopping can be orthogonally multiplexed on same RB(s) without reducing multiplexing capacity.

As indicated above, FIG. 9 is provided as an example. Other examples may differ from what is described with respect to FIG. 9.

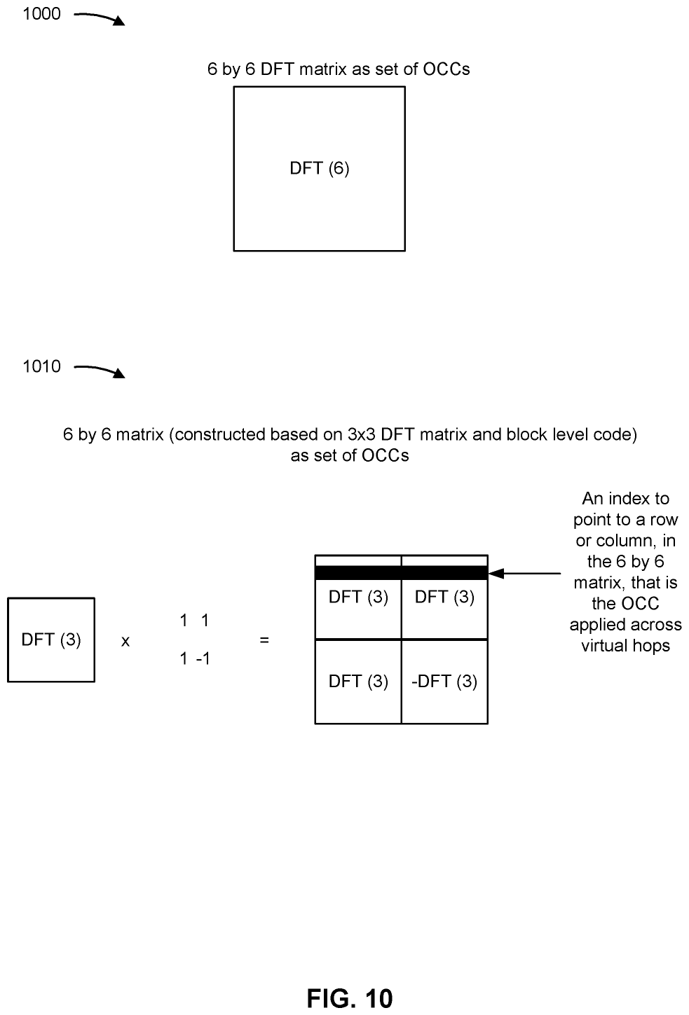

FIG. 10 is a diagram illustrating an example 1000 involving a legacy DFT matrix and an example 1010 involving a matrix that is computed based on block-level OCC (e.g., block OCC) and a half-sized DFT OCC matrix, in accordance with the present disclosure. In examples 1000 and 1010, the matrix contains M/2=6 rows or columns, where M is the quantity of symbols in a PUCCH transmission. Both matrices are 6-by-6 and may be used to determine a set of OCCs for one or more UEs.

In example 1000, a format 1 PUCCH without frequency hopping is signaled by the RRC parameter time DomainOCC, which indicates an index of the DFT OCC code of size M/2. For example, the timeDomainOCC parameter points to a row or column of the legacy matrix. Thus, the time DomainOCC parameter may designate a row or column as the OCC C_i that is applied for a given UE.

As shown in example 1010, a half-sized DFT OCC matrix (e.g., a DFT(3) matrix, which contains three rows or columns, is multiplied by block-level OCC to arrive at the 6-by-6 matrix. Thus, the 6-by-6 matrix may be constructed based at least in part on a DFT matrix (e.g., the DFT(3) matrix) and the block-level OCC. A UE may apply, to one or more virtual hops, DFT OCC corresponding to a row or column of the 6-by-6 matrix. For example, a UE may apply DFT OCC from a first DFT(3) matrix within the 6-by-6 matrix to a first virtual hop and DFT OCC from a second DFT(3) matrix within the 6-by-6 matrix to a second virtual hop. A network mode may signal, to a UE, which DFT OCC to apply to a virtual hop using the RRC parameter time DomainOCC.

In a first aspect for signaling which DFT OCC to apply to a virtual hop, a network node may output, and a UE may receive, an indication of a first index associated with the block-level OCC (e.g., an index of the block code) and a second index associated with the DFT OCC (e.g., an index of the half-sized DFT OCC). Thus, the timeDomainOCC parameter may be used to signal an index of the half-sized DFT OCC and an index of the block code. For example, the timeDomainOCC parameter may be used to determine the first index based on the following relationship: block code index=timeDomainOCC mod 2. The output of time DomainOCC mod 2 may be binary (e.g., 0 or 1). For example, if the output is 0, then the block-level OCC [1,1] may be applied to the virtual hops, and if the output is 1, then the block-level OCC [1,−1] may be applied to the virtual hops. The timeDomainOCC parameter may be used to determine the second index based on the following relationship: index of size M/4 OCC=floor (time DomainOCC/2). The second index may point to one of the three rows of the DFT(3) matrix that is multiplied by the block-level OCC as shown in FIG. 10. Thus, the DFT OCC may be computed based on the first and second indexes, which are derived from the RRC parameter timeDomainOCC.

In a second aspect, a network node may output, and a UE may receive, an indication of an index (e.g., a single index) associated with the block-level OCC and the DFT OCC. For example, as shown in FIG. 10, the index may indicate a row or column in a matrix (e.g., the 6 by 6 matrix) constructed based at least in part on a DFT matrix (e.g., the DFT(3) matrix) and the block-level OCC. The row or column may contain the DFT OCC (e.g., the DFT OCC to be applied to virtual hops). For example, the timeDomainOCC parameter may point to the 6-by-6 OCC matrix of size M/2. For example, the block code index and the index of the size M/4 OCC may be consolidated into a single index that points to a row or column in the 6-by-6 OCC matrix of size M/2. Thus, the DFT OCC may be computed based on a single index, which is based on the RRC parameter time DomainOCC.

As indicated above, FIG. 10 is provided as an example. Other examples may differ from what is described with respect to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with virtual hops for the PUCCH.

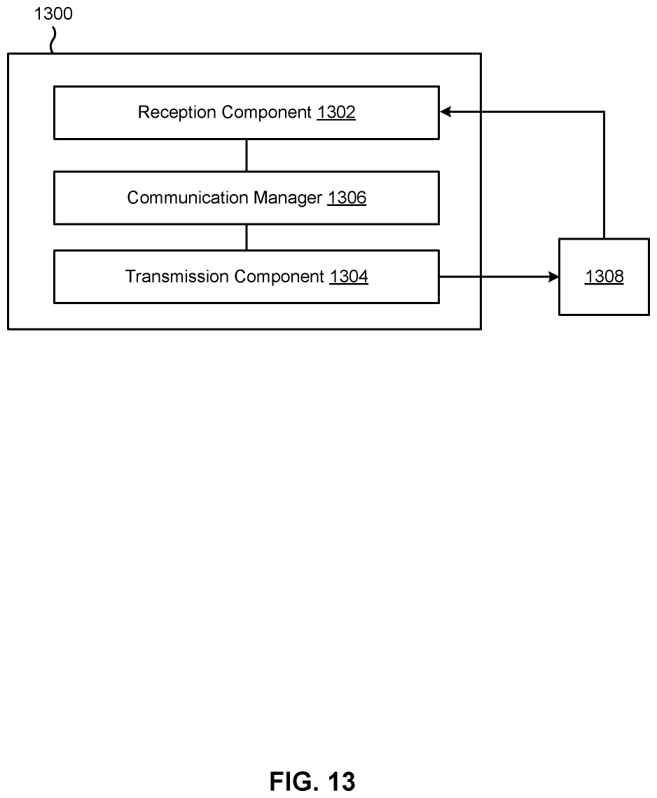

As shown in FIG. 11, in some aspects, process 1100 may include applying a DFT OCC to a first virtual hop that is associated with a PUCCH transmission (block 1110). For example, the UE (e.g., using communication manager 1306, depicted in FIG. 13) may apply a DFT OCC to a first virtual hop that is associated with a PUCCH transmission, as described above.

As further shown in FIG. 11, in some aspects, process 1100 may include applying the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping (block 1120). For example, the UE (e.g., using communication manager 1306, depicted in FIG. 13) may apply the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping, as described above.

Process 1100 may include additional aspects, such as any single aspect or any combination of aspects described below and/or in connection with one or more other processes described elsewhere herein.

In a first aspect, the PUCCH transmission is a first PUCCH transmission, the DFT OCC is a first DFT OCC, a hop, of a second PUCCH transmission, that is multiplexed with the first virtual hop or the second virtual hop on an RB is associated with a second DFT OCC, and a size of the second DFT OCC is the size of the first DFT OCC.

In a second aspect, alone or in combination with the first aspect, the hop of the second PUCCH transmission is associated with physical frequency hopping.

In a third aspect, alone or in combination with one or more of the first and second aspects, the first virtual hop is associated with a DMRS sequence and the second virtual hop is associated with the DMRS sequence.

In a fourth aspect, alone or in combination with one or more of the first through third aspects, the PUCCH transmission is a first PUCCH transmission, and a hop, of a second PUCCH transmission, that is multiplexed with the first virtual hop or the second virtual hop on an RB is associated with the DMRS sequence.

In a fifth aspect, alone or in combination with one or more of the first through fourth aspects, the first virtual hop is associated with a first DMRS sequence and the second virtual hop is associated with a second DMRS sequence that is different from the first DMRS sequence.

In a sixth aspect, alone or in combination with one or more of the first through fifth aspects, the PUCCH transmission is a first PUCCH transmission, and a hop, of a second PUCCH transmission, is multiplexed with the first virtual hop on an RB and is associated with the first DMRS sequence, or the hop is multiplexed with the second virtual hop on the RB and is associated with the second DMRS sequence.

In a seventh aspect, alone or in combination with one or more of the first through sixth aspects, a block-level OCC is applied to the first virtual hop and the second virtual hop.

In an eighth aspect, alone or in combination with one or more of the first through seventh aspects, process 1100 includes receiving an indication of a first index associated with the block-level OCC and a second index associated with the DFT OCC.

In a ninth aspect, alone or in combination with one or more of the first through eighth aspects, process 1100 includes receiving an indication of an index associated with the block-level OCC and the DFT OCC.

In a tenth aspect, alone or in combination with one or more of the first through ninth aspects, the index indicates a row or column in a matrix constructed based at least in part on a DFT matrix and the block-level OCC, and the row or column contains the DFT OCC.

In an eleventh aspect, alone or in combination with one or more of the first through tenth aspects, the DFT OCC is OFDM symbol-level OCC.

In a twelfth aspect, alone or in combination with one or more of the first through eleventh aspects, the PUCCH transmission is a PUCCH format 1 transmission.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with virtual hops for the PUCCH.

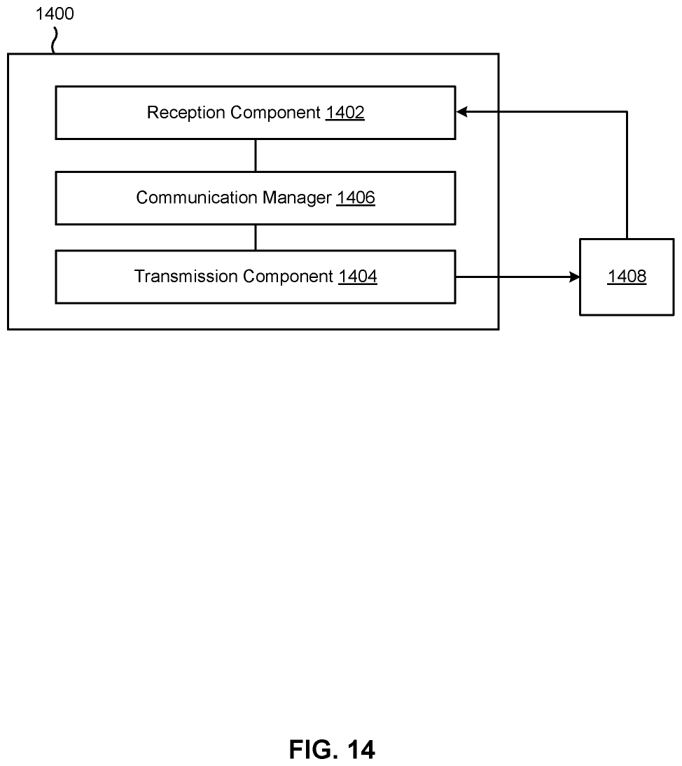

As shown in FIG. 12, in some aspects, process 1200 may include obtaining a first virtual hop that is associated with a PUCCH transmission, wherein a DFT OCC is applied to the first virtual hop (block 1210). For example, the network node (e.g., using reception component 1402 and/or communication manager 1406, depicted in FIG. 14) may obtain a first virtual hop that is associated with a PUCCH transmission, wherein a DFT OCC is applied to the first virtual hop, as described above.

As further shown in FIG. 12, in some aspects, process 1200 may include obtaining a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping (block 1220). For example, the network node (e.g., using reception component 1402 and/or communication manager 1406, depicted in FIG. 14) may obtain a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping, as described above.

Process 1200 may include additional aspects, such as any single aspect or any combination of aspects described below and/or in connection with one or more other processes described elsewhere herein.

In a first aspect, the PUCCH transmission is a first PUCCH transmission, and the DFT OCC is a first DFT OCC, process 1200 includes obtaining a hop, of a second PUCCH transmission, that is multiplexed with the first virtual hop or the second virtual hop on an RB, the hop of the second PUCCH transmission is associated with a second DFT OCC, and a size of the second DFT OCC is the size of the first DFT OCC.

In a second aspect, alone or in combination with the first aspect, the hop of the second PUCCH transmission is associated with physical frequency hopping.

In a third aspect, alone or in combination with one or more of the first and second aspects, the first virtual hop is associated with a DMRS sequence and the second virtual hop is associated with the DMRS sequence.

In a fourth aspect, alone or in combination with one or more of the first through third aspects, the PUCCH transmission is a first PUCCH transmission, process 1200 includes obtaining a hop, of a second PUCCH transmission, that is multiplexed with the first virtual hop or the second virtual hop on an RB, and the hop is associated with the DMRS sequence.

In a fifth aspect, alone or in combination with one or more of the first through fourth aspects, the first virtual hop is associated with a first DMRS sequence and the second virtual hop is associated with a second DMRS sequence that is different from the first DMRS sequence.

In a sixth aspect, alone or in combination with one or more of the first through fifth aspects, the PUCCH transmission is a first PUCCH transmission, process 1200 includes obtaining a hop of a second PUCCH transmission, and the hop of the second PUCCH transmission is multiplexed with the first virtual hop on an RB and associated with the first DMRS sequence, or the hop of the second PUCCH transmission is multiplexed with the second virtual hop on the RB and associated with the second DMRS sequence.

In a seventh aspect, alone or in combination with one or more of the first through sixth aspects, a block-level OCC is applied to the first virtual hop and the second virtual hop.

In an eighth aspect, alone or in combination with one or more of the first through seventh aspects, process 1200 includes outputting an indication of a first index associated with the block-level OCC and a second index associated with the DFT OCC.

In a ninth aspect, alone or in combination with one or more of the first through eighth aspects, process 1200 includes outputting an indication of an index associated with the block-level OCC and the DFT OCC.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIG. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may apply a DFT OCC to a first virtual hop that is associated with a PUCCH transmission. The communication manager 1306 may apply the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping.

The reception component 1302 may receive an indication of a first index associated with the block-level OCC and a second index associated with the DFT OCC.

The reception component 1302 may receive an indication of an index associated with the block-level OCC and the DFT OCC.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIG. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may obtain a first virtual hop that is associated with a PUCCH transmission, wherein a DFT OCC is applied to the first virtual hop. The reception component 1402 may obtain a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

The transmission component 1404 may output an indication of a first index associated with the block-level OCC and a second index associated with the DFT OCC.

The transmission component 1404 may output an indication of an index associated with the block-level OCC and the DFT OCC.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: applying a DFT OCC to a first virtual hop that is associated with a PUCCH transmission; and applying the DFT OCC to a second virtual hop that is associated with the PUCCH transmission, wherein the first virtual hop and the second virtual hop are associated with equal quantities of OFDM symbols, wherein a size of the DFT OCC is based at least in part on the quantities of OFDM symbols, and wherein the first virtual hop and the second virtual hop are not associated with physical frequency hopping.

Aspect 2: The method of Aspect 1, wherein the PUCCH transmission is a first PUCCH transmission, wherein the DFT OCC is a first DFT OCC, wherein a hop, of a second PUCCH transmission, that is multiplexed with the first virtual hop or the second virtual hop on an RB is associated with a second DFT OCC, and wherein a size of the second DFT OCC is the size of the first DFT OCC.

Aspect 3: The method of Aspect 2, wherein the hop of the second PUCCH transmission is associated with physical frequency hopping.

Aspect 4: The method of any of Aspects 1-3, wherein the first virtual hop is associated with a DMRS sequence and the second virtual hop is associated with the DMRS sequence.

Aspect 5: The method of Aspect 4, wherein the PUCCH transmission is a first PUCCH transmission, and wherein a hop, of a second PUCCH transmission, that is multiplexed with the first virtual hop or the second virtual hop on an RB is associated with the DMRS sequence.

Aspect 6: The method of any of Aspects 1-3, wherein the first virtual hop is associated with a first DMRS sequence and the second virtual hop is associated with a second DMRS sequence that is different from the first DMRS sequence.

Aspect 7: The method of Aspect 6, wherein the PUCCH transmission is a first PUCCH transmission, and wherein a hop, of a second PUCCH transmission, is multiplexed with the first virtual hop on an RB and is associated with the first DMRS sequence, or the hop is multiplexed with the second virtual hop on the RB and is associated with the second DMRS sequence.

Aspect 8: The method of any of Aspects 1-7, wherein a block-level OCC is applied to the first virtual hop and the second virtual hop.

Aspect 9: The method of Aspect 8, further comprising: receiving an indication of a first index associated with the block-level OCC and a second index associated with the DFT OCC.

Aspect 10: The method of Aspect 8, further comprising: receiving an indication of an index associated with the block-level OCC and the DFT OCC.

Aspect 11: The method of Aspect 10, wherein the index indicates a row or column in a matrix constructed based at least in part on a DFT matrix and the block-level OCC, and wherein the row or column contains the DFT OCC.

Aspect 12: The method of Aspects 1-11, wherein the DFT OCC is OFDM symbol-level OCC.

Aspect 13: The method of Aspects 1-12, wherein the PUCCH transmission is a PUCCH format 1 transmission.

Aspect 14: A method of wireless communication performed by a network node, comprising: obtaining a first virtual hop that is associated with a PUCCH transmission, wherein a DFT OCC is applied to the first virtual hop; and obtaining a second virtual hop that is associated with the PUCCH transmission, wherein the DFT OCC is applied to the second virtual hop, the first virtual hop and the second virtual hop are associated with equal quantities of OFDM symbols, a size of the DFT OCC is based at least in part on the quantities of OFDM symbols, and the first virtual hop and the second virtual hop are not associated with physical frequency hopping.

Aspect 15: The method of Aspect 14, wherein the PUCCH transmission is a first PUCCH transmission, and wherein the DFT OCC is a first DFT OCC, the method further comprising: obtaining a hop, of a second PUCCH transmission, that is multiplexed with the first virtual hop or the second virtual hop on an RB, wherein the hop of the second PUCCH transmission is associated with a second DFT OCC, and wherein a size of the second DFT OCC is the size of the first DFT OCC.

Aspect 16: The method of Aspect 15, wherein the hop of the second PUCCH transmission is associated with physical frequency hopping.

Aspect 17: The method of any of Aspects 14-16, wherein the first virtual hop is associated with a DMRS sequence and the second virtual hop is associated with the DMRS sequence.

Aspect 18: The method of Aspect 17, wherein the PUCCH transmission is a first PUCCH transmission, the method further comprising: obtaining a hop, of a second PUCCH transmission, that is multiplexed with the first virtual hop or the second virtual hop on an RB, wherein the hop is associated with the DMRS sequence.

Aspect 19: The method of any of Aspects 14-16, wherein the first virtual hop is associated with a first DMRS sequence and the second virtual hop is associated with a second DMRS sequence that is different from the first DMRS sequence.

Aspect 20: The method of Aspect 19, wherein the PUCCH transmission is a first PUCCH transmission, the method further comprising: obtaining a hop of a second PUCCH transmission, wherein the hop of the second PUCCH transmission is multiplexed with the first virtual hop on an RB and associated with the first DMRS sequence, or wherein the hop of the second PUCCH transmission is multiplexed with the second virtual hop on the RB and associated with the second DMRS sequence.

Aspect 21: The method of any of Aspects 14-20, wherein a block-level OCC is applied to the first virtual hop and the second virtual hop.

Aspect 22: The method of Aspect 21, further comprising: outputting an indication of a first index associated with the block-level OCC and a second index associated with the DFT OCC.

Aspect 23: The method of Aspect 21, further comprising: outputting an indication of an index associated with the block-level OCC and the DFT OCC.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.

Aspect 25: An apparatus for wireless communication at a device, the apparatus comprising one or more memories and one or more processors coupled to the one or more memories, the one or more processors configured to cause the device to perform the method of one or more of Aspects 1-23.

Aspect 26: An apparatus for wireless communication, the apparatus comprising at least one means for performing the method of one or more of Aspects 1-23.

Aspect 27: A non-transitory computer-readable medium storing code for wireless communication, the code comprising instructions executable by one or more processors to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

Aspect 29: A device for wireless communication, the device comprising a processing system that includes one or more processors and one or more memories coupled with the one or more processors, the processing system configured to cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
apply a discrete Fourier transform (DFT) orthogonal cover code (OCC) to a first virtual hop that is associated with a physical uplink control channel (PUCCH) transmission; and
apply the DFT OCC to a second virtual hop that is associated with the PUCCH transmission, wherein the first virtual hop and the second virtual hop are associated with equal quantities of orthogonal frequency-division multiplexing (OFDM) symbols, wherein a size of the DFT OCC is based at least in part on the quantities of OFDM symbols, and wherein the first virtual hop and the second virtual hop are not associated with physical frequency hopping.

2. The UE of claim 1, wherein the PUCCH transmission is a first PUCCH transmission, wherein the DFT OCC is a first DFT OCC, wherein a hop, of a second PUCCH transmission, that is multiplexed with the first virtual hop or the second virtual hop on a resource block (RB) is associated with a second DFT OCC, and wherein a size of the second DFT OCC is the size of the first DFT OCC.

3. The UE of claim 2, wherein the hop of the second PUCCH transmission is associated with physical frequency hopping.

4. The UE of claim 1, wherein the first virtual hop is associated with a demodulation reference signal (DMRS) sequence and the second virtual hop is associated with the DMRS sequence.

5. The UE of claim 4, wherein the PUCCH transmission is a first PUCCH transmission, and wherein a hop, of a second PUCCH transmission, that is multiplexed with the first virtual hop or the second virtual hop on a resource block (RB) is associated with the DMRS sequence.

6. The UE of claim 1, wherein the first virtual hop is associated with a first demodulation reference signal (DMRS) sequence and the second virtual hop is associated with a second DMRS sequence that is different from the first DMRS sequence.

7. The UE of claim 6, wherein the PUCCH transmission is a first PUCCH transmission, and
wherein a hop, of a second PUCCH transmission, is multiplexed with the first virtual hop on a resource block (RB) and is associated with the first DMRS sequence, or the hop is multiplexed with the second virtual hop on the RB and is associated with the second DMRS sequence.

8. The UE of claim 1, wherein a block-level OCC is applied to the first virtual hop and the second virtual hop.

9. The UE of claim 8, wherein the one or more processors are further configured to cause the UE to:
receive an indication of a first index associated with the block-level OCC and a second index associated with the DFT OCC.

10. The UE of claim 8, wherein the one or more processors are further configured to cause the UE to:
receive an indication of an index associated with the block-level OCC and the DFT OCC.

11. The UE of claim 10, wherein the index indicates a row or column in a matrix constructed based at least in part on a DFT matrix and the block-level OCC, and wherein the row or column contains the DFT OCC.

12. The UE of claim 1, wherein the DFT OCC is OFDM symbol-level OCC.

13. The UE of claim 1, wherein the PUCCH transmission is a PUCCH format 1 transmission.

14. A network node for wireless communication, comprising:
one or more memories; and
one or more processors, coupled to the one or more memories, configured to cause the network node to:
obtain a first virtual hop that is associated with a physical uplink control channel (PUCCH) transmission, wherein a discrete Fourier transform (DFT) orthogonal cover code (OCC) is applied to the first virtual hop; and
obtain a second virtual hop that is associated with the PUCCH transmission, wherein the DFT OCC is applied to the second virtual hop, the first virtual hop and the second virtual hop are associated with equal quantities of orthogonal frequency-division multiplexing (OFDM) symbols, a size of the DFT OCC is based at least in part on the quantities of OFDM symbols, and the first virtual hop and the second virtual hop are not associated with physical frequency hopping.

15. The network node of claim 14, wherein the PUCCH transmission is a first PUCCH transmission, wherein the DFT OCC is a first DFT OCC, and wherein the one or more processors are further configured to cause the network node to:
obtain a hop, of a second PUCCH transmission, that is multiplexed with the first virtual hop or the second virtual hop on a resource block (RB), wherein the hop of the second PUCCH transmission is associated with a second DFT OCC, and wherein a size of the second DFT OCC is the size of the first DFT OCC.

16. The network node of claim 14, wherein the first virtual hop is associated with a demodulation reference signal (DMRS) sequence and the second virtual hop is associated with the DMRS sequence.

17. The network node of claim 14, wherein the first virtual hop is associated with a first demodulation reference signal (DMRS) sequence and the second virtual hop is associated with a second DMRS sequence that is different from the first DMRS sequence.

18. The network node of claim 14, wherein a block-level OCC is applied to the first virtual hop and the second virtual hop.

19. A method of wireless communication performed by a user equipment (UE), comprising:
applying a discrete Fourier transform (DFT) orthogonal cover code (OCC) to a first virtual hop that is associated with a physical uplink control channel (PUCCH) transmission; and
applying the DFT OCC to a second virtual hop that is associated with the PUCCH transmission, wherein the first virtual hop and the second virtual hop are associated with equal quantities of orthogonal frequency-division multiplexing (OFDM) symbols, wherein a size of the DFT OCC is based at least in part on the quantities of OFDM symbols, and wherein the first virtual hop and the second virtual hop are not associated with physical frequency hopping.

20. The method of claim 19, wherein the PUCCH transmission is a first PUCCH transmission, wherein the DFT OCC is a first DFT OCC, wherein a hop, of a second PUCCH transmission, that is multiplexed with the first virtual hop or the second virtual hop on a resource block (RB) is associated with a second DFT OCC, and wherein a size of the second DFT OCC is the size of the first DFT OCC.
